(19) United States
(12) Patent Application Publication
(10) Pub. No.: US 2024/0042536 A1
(43) Pub. Date: Feb. 8, 2024

(54) HUB FLANGE FOR A TOOL BODY

(71) Applicant: Reishauer AG, Wallisellen (CH)

(72) Inventors: Adrian Marcel HALTER, Wallisellen (CH); Theophil HUG, Wallenwil (CH); Michel MÜLLER, Uster (CH)

(73) Assignee: Reishauer AG, Wallisellen (CH)

(21) Appl. No.: 18/266,976

(22) PCT Filed: Dec. 7, 2021
(86) PCT No.: PCT/EP2021/084599

§ 371 Date: Jun. 13, 2023

(30) Foreign Application Priority Data
Dec. 18, 2020 (CH) 01625/20

(51) Int. Cl. B23F 1/02; B24B 41/04; B23F 23/12

(52) U.S. Cl. CPC B23F 1/023; B24B 41/04; B23F 23/1262

(57) ABSTRACT

A hub flange has a fixed flange configured to receive a tool body. A flange socket is formed on the fixed flange for connection to a spindle shaft. A counterflange is detachably connected to the fixed flange. The fixed flange and the counterflange are connected to each other via a conical connection, wherein the conical connection is arranged coaxially to the tool axis and is formed by an inner cone and an outer cone received therein.

### TECHNICAL FIELD

The present invention relates to a hub flange for a tool body, in particular for a grinding body. The invention further relates to a machining tool comprising such a hub flange and to a tool head equipped therewith.

### PRIOR ART

Hub flanges for grinding wheels are standardized in the standard DIN ISO 666:2013-12. According to this standard, a “hub flange” is a system consisting of a “fixed flange” and a “loose flange” for mounting grinding wheels on a grinding spindle by a friction fit. The loose flange is also referred to as the “counterflange”. The clamping force for the friction fit of the grinding wheel is applied via several screws arranged on a pitch circle, which press the counterflange in the direction of the fixed flange. Integrated in the fixed flange is a socket for the frictional or positive connection with the grinding spindle. This interface of the hub flange to the grinding spindle is called “flange socket”. The part of the grinding spindle that interacts with the flange socket, i.e. the interface of the grinding spindle to the flange socket, is referred to as the “spindle socket”.

FIG. 1 shows, in a central longitudinal section, a grinding tool 100 comprising a prior art hub flange 101 with a grinding wheel 130 clamped therein. Such a hub flange is offered by Reishauer A G, Wallisellen, Switzerland under the designation “B 160”.

The hub flange 101 includes a fixed flange 110 and a counterflange 120. The fixed flange 110 includes a flange socket 111 for connection to a grinding spindle. In operation, the grinding spindle is arranged on the right side of FIG. 1. The fixed flange 110 has a cylindrical outer surface 112 which is delimited on the spindle side by a collar 113. At the end facing away from the spindle, the fixed flange 110 has a connection region 115 with a reduced diameter and a cylindrical outer contour.

The counterflange 120 is annular in shape, having a cylindrical inner lateral surface. It is pushed onto the cylindrical connection region 115 of the fixed flange 110 with this inner lateral surface. Thus, there is a cylindrical plug connection between the fixed flange 110 and the counterflange 120. The counterflange 120 has a cylindrical outer lateral surface 122, the outer diameter of which corresponds to the outer diameter of the cylindrical outer lateral surface 112 of the fixed flange. The outer lateral surface 122 of the counterflange 120 is aligned with the outer lateral surface 112 of the fixed flange 110. A collar 123 is formed at the end of the counterflange 120 facing away from the spindle, which collar 123 delimits the outer lateral surface 122 of the counterflange 120 towards this end. The counterflange 120 is fixed to the fixed flange 110 by a ring of cap screws 125.

The grinding wheel 130 is received with its central bore on the outer lateral surface 112 of the fixed flange 110 and the outer lateral surface 122 of the counterflange 120. Axially, the grinding wheel 130 is clamped between an annular first clamping surface 114 on the collar 113 of the fixed flange 110 and an annular second clamping surface 124 on the collar 123 of the counterflange 120. Optionally, thin intermediate washers may be interposed between the grinding wheel 130 and the clamping surfaces 114 or 124. Cap screws 125, which connect the counterflange 120 to the fixed flange 110, are used to generate the clamping force. At the clamping surfaces 114, 124 there is thus a friction fit between the grinding wheel 130 and the respective collar 113, 123, possibly mediated by the intermediate washers.

Machining tools with small diameters are increasingly being used in gear manufacturing. In order to achieve the desired cutting speed, such tools are usually operated at relatively high rotational speeds. Such tools can be relatively long in relation to their diameter. This makes the tools particularly susceptible to bending and torsional vibrations. However, a prior art hub flange as shown in FIG. 1 is not ideally suited for a long and relatively thin tool. This is particularly true if the tool is to be connected to spindle shafts at both ends.

### SUMMARY OF THE INVENTION

It is an object of the present invention to provide a hub flange which is particularly suitable for receiving tool bodies which have a relatively small diameter in relation to their length.

This object is solved by a hub flange according to claim 1. Further embodiments are given in the dependent claims.

A hub flange for a tool body is proposed. The hub flange defines a tool axis. It comprises a fixed flange adapted to receive the tool body. A first flange socket is formed on the fixed flange for connection to a first spindle shaft which isrotatable about the tool axis. The hub flange further comprises a counterflange which is detachably connected to the fixed flange. The fixed flange and the counterflange are connected to each other via a conical connection, wherein the conical connection is arranged coaxially with respect to the tool axis and is formed by an inner cone (“cone receptacle”) and an outer cone (“cone”) received in the inner cone.

In this document, terms are used according to the definitions of DIN ISO 666:2013-12 given above, with the following exceptions: The term “hub flange” is also used for tool holders on which a type of tool body other than a grinding wheel is clamped. The term “counterflange” is understood more broadly than in DIN ISO 666:2013-12. It also includes structures that are detachably connected to the fixed flange to form a unit without the tool body being clamped directly between the fixed flange and the counterflange.

In contrast to DIN ISO 666:2013-12, the hub flange may be intended to be connected to a spindle shaft at each end. For this purpose, the counterflange may have a second flange socket for connection to a second spindle shaft. Since the counterflange is detachable from the fixed flange in order to change the tool body, the diameter of the second flange socket may be largely freely selected and, in particular, may be larger than the inner diameter of the bore of the tool body if required. In this way, even for tools with a small bore diameter, the second flange socket can be designed sufficiently large to be able to transmit a sufficient torque via this flange socket.

By having a conical connection formed between the fixed flange and the counterflange, a precisely centered connection is created which, on the one hand, is backlash-free and, on the other hand, is particularly resistant to bending. In contrast to a hub flange of the prior art as shown in FIG. 1, a friction fit between the fixed flange and the counterflange is no longer effected solely via the tool body clamped therebetween, but the friction fit may be effected directly between the fixed flange and the counterflange in the region of the conical connection. In particular, it becomes possible to design the hub flange in such a way that a clamping force with which the tool body is held on the hub flange becomes largely independent of the force with which the fixed flange and the counterflange are axially pressed together at the conical connection.

This has particular advantages when the tool is connected to spindle shafts on both sides and, for this purpose, the hub flange is clamped axially in compression between the two spindle shafts, so that an axial compression force acts on the hub flange on both sides. Whereas in the case of a hub flange of the prior art, as shown in FIG. 1, such a compression force would be transmitted to the tool body and could result in damage to the tool body, in the present invention the compression force is transmitted directly at the conical connection between the fixed flange and the counterflange and can thus be decoupled from the tool body.

The proposed configuration also allows considerably higher torques to be transmitted between the fixed flange and the counterflange than is possible in the pior art according to FIG. 1. This has particular advantages, for example, if the hub flange is to be driven on both sides. If, for example, the two drives generate different torques, the direct coupling between the fixed flange and the counterflange at the conical connection prevents the torque difference from being transmitted to the tool body.

The inner cone of the conical connection may be formed on the fixed flange and the outer cone on the counterflange. Alternatively, the inner cone may be formed on the counterflange and the outer cone on the fixed flange. The half opening angle of the conical connection, i.e. the single taper angle of the conical surfaces relative to the tool axis, may be, for example, 10 to 30°, preferably 2° to 10°. The length of the conical connection may be chosen to be very short in a projection onto the tool axis, but should preferably be at least 3 mm.

Preferably, the connection between the fixed flange and the counterflange is a conical connection with axial face contact. A significant advantage of the conical connection with axial face contact is that the two parts (fixed flange and counterflange, including the flange sockets formed thereon for connection to the respective spindle shaft) are not only precisely centred, but are also precisely positioned axially in relation to each other. This allows these two parts to be reconnected just as precisely when the grinding wheel is changed, during which the two parts must be separated. The connection between the flange and the counterflange therefore has an important quality-assuring function during the manufacture of the hub flange. The additional axial face contact also allows a higher axial force to act between the fixed flange and the counterflange than with a pure conical connection. This means that a higher torque may be transmitted between these elements. In addition, the torsional and bending stiffness may be further improved.

For axial face contact, a first axial plane contact surface is formed adjacent to the inner cone on the component (fixed flange or counterflange) on which the inner cone is formed, and a second axial plane contact surface oriented opposite to the first plane contact surface is formed adjacent to the outer cone on the component on which the outer cone is formed.

The fixed flange and the counterflange are pressed together at the first and second axial plane contact surfaces to establish a friction fit. In this regard, it is advantageous if the first and second axial plane contact surfaces are arranged adjacent to the respective cone. In particular, the first planar contact surface is preferably arranged in a region adjacent to the end face of the inner cone and radially surrounding the end face of the inner cone. Accordingly, the second planar contact surface is preferably arranged in a region radially surrounding the outer cone. Radially between the front end of the inner cone and the first plane contact surface, a weakening may be introduced into the material of the component concerned (fixed flange or counterflange) in order to increase the radial extensibility of the inner cone.

In order to fix the counterflange to the fixed flange, axially aligned screws are advantageously provided. These press the fixed flange and the counterflange axially together in such a way that an axial pressing force acts between the fixed flange and the counterflange. The screws are advantageously evenly distributed around the tool axis to minimize unbalance.

In order to clamp the tool body axially in the hub flange, the hub flange preferably defines a first and a second clamping surface facing each other so that the tool body can be clamped axially in compression between the first and the second clamping surface. Preferably, the clamping surfaces extend orthogonally to the tool axis. Thereby, the tool body is not necessarily clamped directly between the first and second clamping surfaces. For example, an intermediate washer can be inserted between the respective clamping surface and the tool body. This intermediate washer may be made of aluminium, for example. It may be very thin, for example less than 1 mm thick.

In particular, the hub flange may comprise a positioning ring having an axially variable position relative to the counterflange, wherein the first clamping surface is formed on the fixed flange, and wherein the second clamping surface is formed on the positioning ring.

This makes it possible to clamp tool bodies of different widths in the hub flange, although the relative position of the fixed flange and the counterflange is fixed by the conical connection and the face contact.

In order to change the axial position of the positioning ring, the fixed flange or preferably the counterflange may have an external thread, and the positioning ring may have a internal thread complementary thereto. By a screwing movement of the positioning ring, the axial position of the positioning ring may be adjusted. Fixation elements may be provided on or in the positioning ring, for example radial fixation pins which prevent unintentional rotation of the positioning ring in a fixed position. Axially adjacent to the positioning ring, an intermediate ring may be arranged to transmit an axial clamping force from the positioning ring to the tool body. The intermediate ring then provides a gliding surface for the clamping surface of the positioning ring without rotating itself. The intermediate ring prevents direct friction between the positioning ring and the tool body during a screwing movement of the positioning ring. In order to generate a defined clamping force on the tool body even when the length of the tool body changes, e.g. due to settling processes, the intermediate ring may have elastic properties.

In alternative embodiments, the positioning ring may be axially displaceable relative to the fixed flange and/or relative to the counterflange, and threaded elements may be provided which are screwed into the counterflange or into the positioning ring in order to change the axial position of the positioning ring relative to the counterflange. The threaded elements may, for example, be screws whose axial position relative to the counterflange is fixed and which may be screwed into or out of the positioning ring to different extents to vary the axial position thereof. Alternatively, the threaded elements may be set screws which may be screwed in and out of the counterflange to different extents and which exert an axial compression force on the positioning ring with a distal end. In order to generate a defined clamping force on the tool body even when the length of the tool body changes, the screw connection can be combined with a resilient element. For example, axially resilient elements, e.g. bushings with disc springs, may be provided in the positioning ring, on which said set screws exert axial pressure.

The hub flange is also preferably connected to the spindle shafts via conical connections, preferably also with face contact. This enables very precise centering of the hub flange in the grinding head. For example, the connection can be made via one of the embodiments A, BF, BM, CF or CM mentioned in DIN ISO 666:2013-12. For this purpose, the first and/or second flange socket may be configured as an inner or outer cone with a plane contact surface. However, alternative types of connection between the hub flange and the spindle shafts are also conceivable, e.g. via radially acting hydraulic expansion elements.

It is advantageous if the two flange sockets are configured differently in such a way that the tool can only be received in a predetermined position between the spindle shafts. For example, the diameters of the two flange sockets may be different.

The present invention further provides a machining tool comprising a hub flange of the type described above and a tool body clamped on the hub flange. While by design the hub flange is particularly well suited for long tool bodies of relatively small diameter (e.g., length to diameter ratio greater than 1), the invention is not limited to such tool bodies. Thus, the tool body may have any length-to-diameter ratio. In particular, the machining tool may be a grinding tool, in particular a tool for gear grinding. Accordingly, the tool body may be a single-part or multi-part grinding body. The grinding body may in particular be vitrified-bonded and thus dressable. For example, it may comprise abrasive grains of corundum or of cubic boron nitride (cBN). However, the abrasive body may also be polymer-bonded, for example, and may in particular be designed as an abrasive body for polishing grinding. The tool body may alternatively or additionally comprise, for example, a metallic base body with a non-dressable hard material coating. Any combination of similar or different tool bodies is also conceivable. In particular, the tool body may comprise a grinding wheel with a worm-shape profiled outer contour (grinding worm) and/or a profile grinding wheel. In the case of a multi-part tool body, the tool body may in particular be a combination of two or more grinding worms, for example a roughing grinding worm with a finishing or polishing grinding worm, a combination of a grinding worm with a profile grinding wheel, or a combination of two or more profile grinding wheels.

The present invention further provides a tool head for a machine tool, in particular for a gear cutting machine. The tool head comprises a machining tool of the type mentioned above. It further comprises a first spindle unit with a first spindle shaft which is mounted in the first spindle unit so as to be rotatable about the tool axis, and a second spindle unit with a second spindle shaft which is mounted in the second spindle unit so as to be rotatable about the tool axis. The first spindle unit and the second spindle unit are arranged coaxially with respect to each other in such a way that the machining tool is axially receivable between the first spindle shaft and the second spindle shaft. In order to receive the tool between the spindle shafts and to be able to transmit a torque to the tool, it is advantageous if a spindle nose is formed on the first and/or second spindle shaft in such a way that a non-positive and/or positive connection to the tool may be produced at the respective spindle nose by an axial compression force acting between the tool and the spindle nose, in particular via the conical connection already mentioned.

In some embodiments, the first spindle unit and the second spindle unit are accommodated in a common spindle housing. The second spindle bearing may then be held in a bearing receptacle that is axially displaceable relative to the common spindle housing to allow the machining tool to be changed. In other embodiments, the two spindle units are accommodated in separate spindle housings, these spindle housings being displaceable relative to each other along the workpiece axis in order change the machining tool.

Particular advantages result if the two spindle shafts are axially clamped with the machining tool so that an axial compression force acts on the machining tool on both sides. For this purpose, the following design is particularly advantageous: the second spindle shaft has at least one axial bore. The tool head correspondingly comprises at least one pull rod extending through the corresponding axial bore of the second spindle shaft, the pull rod being connectable at a first end to the first spindle shaft. The pull rod is connectable at its second end to the second spindle shaft such that an axial compression force can be generated on the tool between the first spindle shaft and the second spindle shaft. For this purpose, the machining tool, specifically its hub flange, correspondingly also has at least one axial bore, so that the respective pull rod may be passed through the corresponding bore of the machining tool.

This type of axial bracing creates a unit of the two spindle shafts and the tool, which is particularly resistant to torsion and bending. The combination of pull rod and clamping element enables a high axial compression force between the machining tool and the two spindle shafts. As a result, the aforementioned unit acts as a single shaft. At the same time, this construction can be very compact. This makes this construction particularly suitable for machining tools with a small diameter. Thanks to the direct connection of the fixed flange with the counterflange at the conical connection, the high axial compression force is not or only to a small extent transmitted to the tool body.

However, said construction with pull rod is also advantageous when the tool is formed differently from the type discussed above. In this respect, the present invention also relates to a tool head for a machine tool, in particular for a gear cutting machine, comprising:
a first spindle unit having a first spindle shaft which mounted in the first spindle unit so as to be rotatable about a tool spindle axis; and
a second spindle unit with a second spindle shaft which is mounted in the second spindle unit so as to be rotatable about the tool spindle axis,
wherein the first spindle unit and the second spindle unit are arranged such that a tool is axially receivable between the first spindle shaft and the second spindle shaft to drive the tool to rotate about the tool spindle axis,
wherein the second spindle shaft has at least one axial bore,
wherein the tool head comprises at least one pull rod extending through the axial bore of the second spindle shaft,
wherein the pull rod is connectable at an end to the first spindle shaft so as to be tensioned, and
wherein the pull rod is connectable at its other end to the second spindle shaft in such a way that an axial compression force can be generated on the tool between the first spindle shaft and the second spindle shaft.

Preferably, there is exactly one pull rod extending through a central axial bore in the second spindle shaft. Accordingly, it is preferred that the hub flange also has a central axial bore through which the pull rod can be passed.

In a particularly simple embodiment, the pull rod is connectable to the first spindle shaft by screwing it axially into the first spindle shaft. For this purpose, complementary threads can be formed on the corresponding end of the pull rod and on the first spindle shaft. However, other types of connection are also conceivable, for example a bayonet-type connection.

The pull rod may advantageously be provided at its other, free end with a clamping element forming an annular contact surface, the annular contact surface bearing against the second spindle shaft after the pull rod has been connected to the first spindle shaft and generating an axial compression force on the second spindle shaft in order to push it in the direction of the first spindle shaft. In the simplest case, the pull rod may be formed for this purpose, for example, as a screw having a screw head. The screw may then be screwable into the first spindle shaft, and the screw head may form the clamping element. The axial clamping force is then generated simply by tightening the screw.

In another, also very simple embodiment, the pull rod is provided at its free end with an external thread onto which a nut can be screwed. In this case, the nut forms the clamping element and the axial compression force is generated quite simply by tightening the nut.

Preferably, however, the tool head comprises a clamping element that is releasably connectable to the pull rod and generates a compression force that preferably acts purely axially, without a tightening of the clamping element generating a torque component about the tool spindle axis. For this purpose, the clamping element comprises a base element which is rigidly connectable to the pull rod, for example via a screw connection, via a bayonet or via a clamping bush. The base element may have a central receiving opening to receive the pull rod, or (if sufficient space is available) a pin fixable in an axial bore of the pull rod. The clamping element further comprises an axial push element which is axially movable, in particular axially displaceable, relative to the base element in the direction of the second spindle shaft in order to push the second spindle shaft axially in the direction of the first spindle shaft. The axial push element may in particular be annular and surround the central receiving opening or the pin of the base element, in which case the axial push element may also be referred to as a “push ring”. The axial push element forms the annular contact surface already mentioned. The clamping element further comprises at least one actuating element, the actuating element being movable relative to the base element to axially move the axial push element relative to the base element. The actuating element may be, for example, a pressure screw which can be screwed into the base element along a longitudinal or transverse direction. Such clamping elements are known per se from the prior art and are commercially available in many variants.

In some embodiments, the transmission of force from the actuating element to the axial push element is purely mechanical. For example, the actuating elements may be a plurality of cap screws axially retained on the base element and screwable into the axial push element to axially displace the axial push element relative to the base element. In other embodiments, one or more set screws, which are adjustable in the base element in the direction of the axial push element via a threaded connection, serve as actuating elements. In still other embodiments, the actuating element acts, for example, on a gear that advances the axial push element. Such clamping elements are available, for example, under the designations ESB, ESG or ESD from Enemac GmbH, Kleinwallstadt, Germany.

In other embodiments, the transmission of force from the actuating element to the axial push element is hydraulic. For this purpose, the actuating element may be configured, for example, as a pressure screw which generates a pressure in a hydraulic system when it is screwed in, this pressure acting on the axial push element. Such clamping elements are available, for example, from Albert Schrem Werkzeugfabrik GmbH, Herbrechtingen, Germany.

Instead of generating the axial compression force between the pull rod and the second spindle shaft with a clamping element which remains on the pull rod during operation, it is also conceivable to first generate the compression force with a clamping tool, to fix the connection in the clamped state with a simple nut, and to subsequently remove the clamping tool again.

However, the tool may also be clamped between the first spindle shaft and the second spindle shaft in a way other than with a continuous pull rod, as long as this results in a firmly clamped unit comprising the two spindle shafts and the tool. Thus, embodiments are conceivable in which a first pull rod is connectable to the tool at a first end, for example screwable to the tool or connectable via a hollow shank taper connection. The first pull rod may then extend through an axial bore of the first spindle shaft and may be connectable at its second end to the first spindle shaft in such a way that an axial compression force can be generated between the first spindle shaft and the tool. A second pull rod may be arranged on the opposite side of the tool. This second pull rod may in turn be connectable to the tool at a first end, for example screwable to the tool or connectable via a hollow shank taper connection. The second pull rod may then extend through an axial bore of the second spindle shaft and may be connectable at its second end to the second spindle shaft such that an axial compression force can be generated between the second spindle shaft and the tool.

As an alternative to axial bracing with a pull rod, the hub flange may also be connectable to at least one spindle shaft in another way. In particular, the hub flange may be provided with at least one thread, preferably a threaded bore, for connecting the at least one spindle shaft to the hub flange.

In order to facilitate the tool change, it is advantageous if the second spindle unit is axially displaceable relative to the first spindle unit. If both spindle units are accommodated in a common spindle housing, this can be achieved by having the spindle bearings for the second spindle shaft being axially displaceable relative to this spindle housing.

The first and/or second spindle units may include a drive motor configured to drive the corresponding spindle shaft to rotate about the tool spindle axis, thereby driving the tool. In some embodiments, only the first spindle unit comprises a drive motor, and the second spindle unit forms a passive counter spindle for the first spindle unit, without an own drive motor. In other embodiments, the second spindle unit also comprises its own drive motor. The respective drive motor may in particular be a direct-drive.

The present invention further provides a machine tool comprising a tool head of the type mentioned above and at least one workpiece spindle for driving a workpiece to rotate about a workpiece axis. The machine tool may be configured as a gear cutting machine, in particular as a gear grinding machine. For this purpose, the machine tool may comprise a machine control system configured (in particular appropriately programmed) to cause the machine to machine a gear teeth of a workpiece received on the at least one workpiece spindle with the tool. In particular, the machine control system may be configured to cause the machine to machine the gear teeth of the workpiece by profile grinding or generating gear grinding. For this purpose, the machine control system may be configured to establish a suitable rolling coupling between the workpiece spindle and the tool spindle.

### BRIEF DESCRIPTION OF THE DRAWINGS

Preferred embodiments of the invention are described below with reference to the drawings, which are for explanatory purposes only and are not to be construed in a limiting manner.

In the drawings,

FIG. 1 shows a grinding tool comprising a hub flange according to the prior art, in a central longitudinal section;

FIG. 2 shows a grinding tool comprising a hub flange according to a first embodiment of the present invention, in a perspective view;

FIG. 3 shows the grinding tool of FIG. 2 in a central longitudinal section;

FIG. 4 shows the hub flange of the grinding tool of FIG. 2 in a perspective view;

FIG. 5 shows an enlarged detail of the hub flange of FIG. 4 in a central longitudinal section in the plane V-V of FIG. 6;

FIG. 6 shows the hub flange of FIG. 4 in a frontal view of the counterflange;

FIG. 7 shows a part of a central longitudinal section through a grinding tool with a hub flange according to a second embodiment;

FIG. 8 shows a part of a central longitudinal section through a grinding tool with a hub flange according to a third embodiment;

FIG. 9 shows a part of a central longitudinal section through a grinding tool with a hub flange according to a fourth embodiment;

FIG. 10 shows a tool head in a schematic perspective view;

FIG. 11 shows the tool head of FIG. 10 in a perspective sectional view;

FIG. 12 shows a clamping nut in a central longitudinal section;

FIG. 13 shows a perspective view of the clamping nut of FIG. 13; and

FIG. 14 shows a machine tool for hard finishing of gears by generating gear grinding in a schematic perspective view.

### DESCRIPTION OF PREFERRED EMBODIMENTS

### Definitions

Gear cutting machine: A machine configured to produce or machine gear teeth on workpieces, in particular internal or external gear teeth of gears. For example, a gear cutting machine can be a machine for fine machining, with which pre-toothed workpieces are machined, in particular a hard finishing machine with which pre-toothed workpieces are machined after hardening. A gear cutting machine comprises a machine control system programmed to control automatic machining of the gear teeth.

Generating machining of gears: A type of gear machining in which a tool rolls on a workpiece, producing a cutting motion. Various gear generating machining processes are known, whereby a distinction is made between processes with a geometrically undefined cutting edge, such as gear grinding or gear honing, and processes with a geometrically defined cutting edge, such as gear hobbing, gear peeling, gear shaving or gear shaping.

Generating gear grinding: The generating gear grinding process is a continuous chip-removing process with a geometrically undefined cutting edge for the production of axially symmetrical periodic structures, in which a grinding wheel with a worm-shaped profiled outer contour (“grinding worm”) is used as the tool. Tool and workpiece are mounted on rotation spindles. By coupling the rotation movements of tool and workpiece around the rotation axes, the rolling motion typical of the process is realized. This rolling motion and an axial feed motion of the tool or the workpiece along the workpiece axis generate a cutting motion.

Tool head: In the present document, the term “tool head” refers to an assembly configured to receive and drive a machining tool for rotation. In particular, the tool head may be mounted on a swivel body and/or one or more slides to align and position the tool relative to a workpiece.

Spindle unit: In machine tool construction, a rotatable shaft on which a tool or workpiece can be clamped is usually referred to as a “spindle”. However, an assembly which, in addition to the rotatable shaft, also includes the associated spindle bearings for rotatably bearing the shaft and the associated housing is also frequently referred to as a “spindle”. In the present document, the term “spindle” is used in this sense. The shaft alone is referred to as the “spindle shaft”. An assembly comprising, in addition to the spindle shaft, at least the associated spindle bearings is referred to as a “spindle unit”. A “spindle unit” may comprise its own housing, but it may also be accommodated in a common housing together with another spindle unit.

### Hub Flange According to the First Embodiment

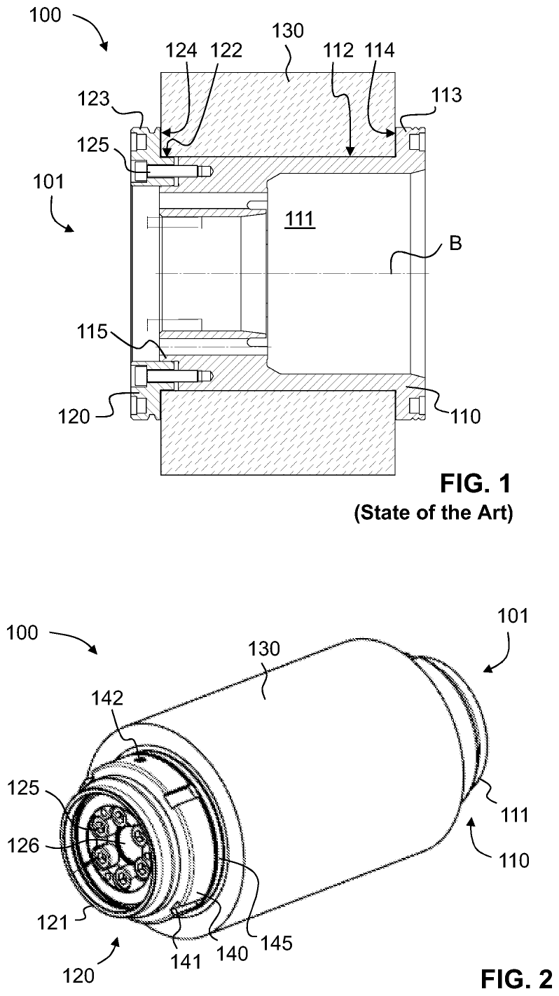

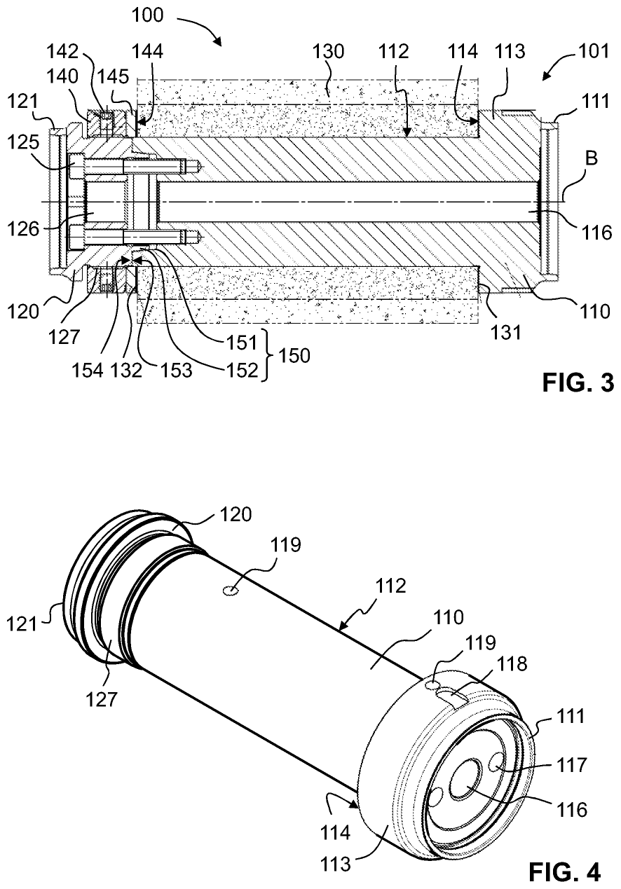

FIGS. 2 and 3 illustrate a machining tool 100. The machining tool 100 comprises a hub flange 101 in which a tool body 130 is clamped. The hub flange 101 is shown alone in FIGS. 4 to 6. Functionally similar parts are provided with the same reference signs as in FIG. 1.

In the present example, the tool body 130 is a grinding tool. Thus, the machining tool 100 in the present example is a grinding tool. However, other types of tool bodies 130 may also be provided.

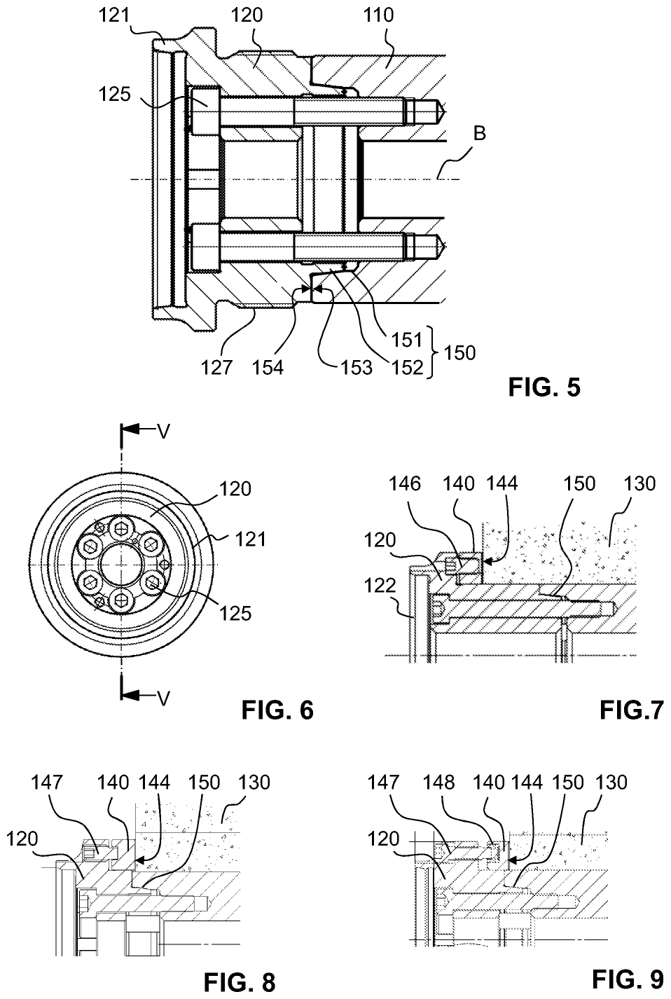

The hub flange 101 defines a tool axis B about which it can rotate. It comprises a fixed flange 110 and a counterflange 120. The fixed flange 110 has, at its right-hand end in FIG. 3, a first flange socket 111 for connection to a first spindle shaft. In the present example, the first flange socket 111 is formed as an inner cone (“taper socket”) with a plane contact surface arranged inside the inner cone, specifically as a short taper receptacle 1:4 according to DIN ISO 702-1:2010-04. The fixed flange 110 has a cylindrical outer lateral surface 112. The lateral surface 112 is delimited by a collar 113 at that end of the fixed flange 110 at which the first flange socket 111 is formed. The collar 113 has an enlarged outer diameter. It forms an annular first clamping surface 114 for the tool body 130. The first clamping surface 114 extends in a plane orthogonal to the tool axis B. A central bore 116 extends along the tool axis B through the fixed flange 110. Positioning bores 117 serve to position and fix the fixed flange 110 in the circumferential direction during clamping of the tool body 130. A machine-readable data carrier, for example an RFID tag or an optical code, may be arranged in a receiving notch 118 on the outer circumference. Balancing holes 119 are provided for balancing and/or allow additional balancing weights to be attached. At its left-hand end in FIG. 3, i.e. at the end facing away from the first flange socket 111, a further inner cone (“taper socket”) 151 is formed on the fixed flange 110. This inner cone 151 is particularly well visible in FIG. 5. The region of the end face of the fixed flange 110 adjacent to the inner cone 151 and surrounding the inner cone 151 forms a first plane contact surface 153. The first plane contact surface 153 extends orthogonally to the tool axis B.

The counterflange 120 has a second flange socket 121 at its end located on the left in FIG. 3, i.e. at the end facing away from the first flange socket 111. Here, the second flange socket 121 is also formed as an inner cone (“taper socket”) with a plane contact surface arranged inside the inner cone, specifically as a short taper receptacle 1:4 according to DIN ISO 702-1:2010-04. At its end located on the right in FIG. 3, i.e. at its end facing the fixed flange 110, an outer cone (“taper”) 152 is formed on the counterflange 120, which is complementary to the inner cone (“taper socket”) 151 on the fixed flange 110. The outer cone 152 is radially surrounded by an annular second plane contact surface 154 (see FIG. 6), which faces the first plane contact surface 153 on the fixed flange. A central bore 126 extends along the tool axis B through the counterflange 120. The bore 126 is aligned with the bore 116 of the fixed flange 110. The bores 116, 126 together form a continuous axial bore through the hub flange 101.

The counterflange 120 is connected to the fixed flange 110 via a conical connection with face contact. The taper connection 150 is established by the inner taper 151 on the fixed flange 110 and the complementary outer taper 152 on the counterflange 120. The face contact is made at the two complementary plane contact surfaces 153, 154.

An essential advantage of this construction is that, due to this division of the hub flange, especially in the case of small grinding wheels, the diameters of the flange sockets 111, 121 for the transmission of the torque may be selected decisively larger on both sides than if both flange sockets were arranged on the fixed flange. However, since any separation is also disadvantageous, a connection with high rigidity is required. This is ensured by the conical connection with face contact. In addition, this type of connection also ensures that the fixed flange 110 and the counterflange 120 fit perfectly again after each grinding wheel change and can be easily separated again.

The counterflange 120 is fixed to the fixed flange 110 by a plurality of cap screws 125 evenly distributed in the circumferential direction. The cap screws 125 generate a defined axial contact pressure force between the fixed flange 110 and the counterflange 120. This axial contact pressure force is transmitted directly via the conical connection with face contact between the fixed flange 110 and the counterflange 120.

An external thread 127 is formed on an outer lateral surface of the counterflange 120. A positioning ring 140 is screwed onto the external thread 127. A plurality of longitudinal grooves 141 are formed on the outer circumference of the positioning ring 140 to allow the positioning ring 140 to be rotated with a suitable wrench. The positioning ring 140 can be fixed to the counterflange 120 with radial fixation pins 142, to prevent unintentional rotation of the positioning ring 140. The positioning ring 140 forms a second clamping surface 144 on its end face facing the fixed flange 110. The second clamping surface 144 extends in a plane that is perpendicular to the tool axis B. The second clamping surface faces in the direction of the first clamping surface 114 on the fixed flange 110.

The tool body 130 has a central bore along the tool axis B. The tool body 130 is pushed with this bore onto the fixed flange 110. In the region of its bore, it rests with an inner lateral surface on the outer lateral surface 112 of the fixed flange 110. The tool body 130 is axially supported on the first clamping surface 114 on the fixed flange 110. A thin intermediate washer 131, which may be made of e.g. aluminium, may be provided between the tool body 130 and the first clamping surface 114. The tool body 130 is fixed to the hub flange 101 by means of the positioning ring 140 and an intermediate ring 145. Again, a thin intermediate washer 132 may be provided between the tool body and the intermediate ring 145, which again may be made of aluminium. In this case, the positioning ring 140 exerts an axial clamping force on the tool body 130 with the second clamping surface 144 via the intermediate ring 145 and, if applicable, the intermediate washer 132. By suitable positioning of the positioning ring 140, this axial clamping force may be adjusted independently of the axial contact pressure between the fixed flange 110 and the counterflange 120.

To clamp the tool body 130, the following procedure is followed. First, the counterflange 120 is loosened from the fixed flange 110. The positioning ring 140 is screwed back as far as possible in the direction of the second flange socket 121, and the intermediate ring 145 is pushed back as far as possible. The tool body 130 and, if necessary, the intermediate washers 131, 132 are slid onto the fixed flange 110, and the counterflange 120 is fixed to the fixed flange 110 by the screws 125. The screws 125 are now tightened until there is a sufficient axial contact force between the fixed flange 110 and the counterflange 120. The tool body 130 is not yet axially clamped during this process. Only after the connection between the fixed flange 110 and the counterflange 120 has been established, the positioning ring 140 is now screwed forward until the desired axial clamping force is applied to the tool body 130 via the intermediate ring 145. The axial clamping force on the tool body 130 is thus set independently of the axial contact force between the fixed flange 110 and the counterflange 120.

The hub flange 101 may be configured to accommodate only a particular type of tool body 130. For example, depending on the type of tool body 130, different outer diameters of the outer lateral surface 112 may be provided. In particular, a larger outer diameter may be provided for abrasive bodies with abrasive grains of corundum than for abrasive bodies with abrasive grains of cBN. In this way, it is reliably prevented that a cBN abrasive body may be mistakenly mounted on a hub flange provided for a corundum abrasive body and vice versa. Instead of having different diameters for different tool types, this can also be achieved by different shaping, e.g. by providing grooves, forming a polygonal region, or forming a serration on the hub flange.

To ensure that the two flange sockets 111, 121 are precisely aligned with each other, the fixed flange 110 and the counterflange 120 are each manufactured in pairs, including balancing.

### Second to Fourth Embodiment

In FIG. 7, a second embodiment is illustrated. This embodiment differs from the first embodiment primarily in the manner in which the tool body 130 is clamped in the hub flange 101. As in the first embodiment, a positioning ring 140 is provided for this purpose. This positioning ring is axially displaceable relative to the counterflange 120. A plurality of adjusting screws 146 in the form of cap screws are screwed into the positioning ring 140. The adjusting screws 146 are evenly distributed in the circumferential direction. They are axially supported on the counterflange 120, so that they are prevented from moving axially in the direction of the second flange socket 122. When the cap screws 146 are screwed out of the positioning ring 140, they press the positioning ring 140 axially against the tool body 130, thereby generating an axial clamping force.

In FIG. 8, a third embodiment is illustrated. This embodiment also differs from the first embodiment primarily in the manner in which the tool body 130 is clamped in the hub flange 101. Again, the positioning ring 140 is axially displaceable relative to the counterflange 120. Positioning pins 147 in the form of set screws, which are guided in threads in the counterflange 120, serve this purpose. When the positioning pins 147 are screwed into the counterflange, they push the positioning ring 140 axially against the tool body 130 to create the axial clamping force.

FIG. 9 illustrates a fourth embodiment. This embodiment corresponds largely to the third embodiment. However, in contrast to the third embodiment, axial spring elements 148 in the form of spring bushings are arranged in the positioning ring 140. The positioning pins 147 act on these spring elements. Due to their elastic properties, the spring elements ensure that a sufficient axial clamping force is still applied to the tool body 130 even if the length of the tool body 130 changes, for example due to settling processes in the tool body 130.

Tool Head with Machining Tool

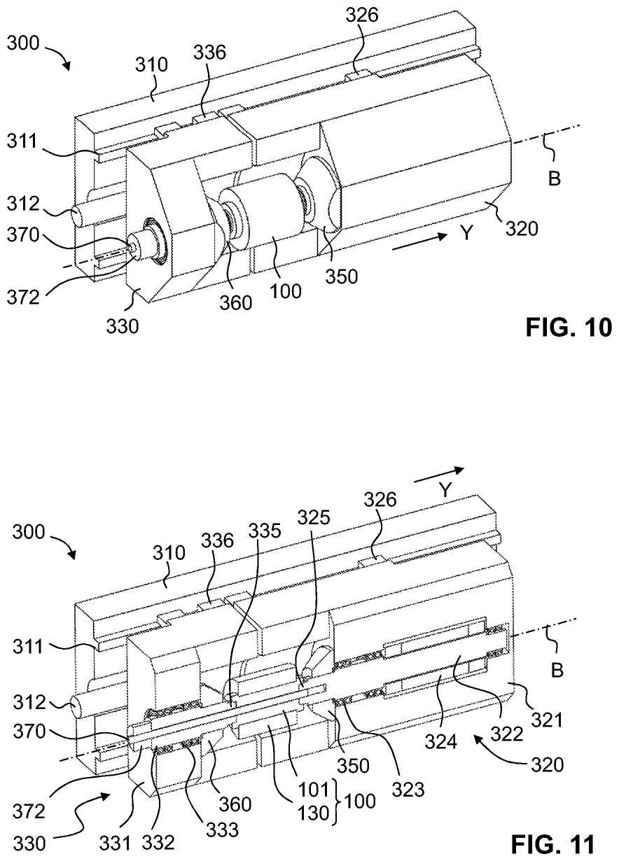

FIGS. 10 and 11 illustrate a tool head with a machining tool 100 according to one of the embodiments discussed above. For the sake of clarity, the machining tool 100 is shown only schematically.

The tool head includes a base 310. A linear guide 311 is formed on the base 310. A first spindle unit 320 and a second spindle unit 330 are displaceable guided along a shift direction Y on the linear guide 311. For this purpose, the spindle units each have corresponding guide shoes 326, 336. The machining tool 100 is held between the spindle units 320, 330. The tool axis B runs parallel to the shift direction Y.

The second spindle unit 320 and the first spindle unit 330 can be coupled to each other after the machining tool 100 is received between them. When coupled, they can be moved together along the shift direction Y by a shift drive not shown in the drawing and a ball screw 312 to change the tool area that is in engagement with a workpiece along the tool axis.

In the present example, the spindle unit 320 is a motorized spindle having a drive motor 324 that drives a first spindle shaft 322 to rotate about the tool axis B. The first spindle shaft 322 is supported in spindle bearings 323 in the spindle housing 321 of the first spindle unit 320. In the present example, the second spindle unit 330 is a counter spindle with a non-driven second spindle shaft 332 supported in the spindle housing 331 of the second spindle unit 330 in spindle bearings 333. However, both spindle units 320, 330 may instead be driven.

At the tool-side ends of the spindle shafts 322, 332, opposing spindle sockets in the form of spindle noses 325, 335 are formed. The shape of the spindle noses is complementary to the shape of the flange sockets 111, 121 of the hub flange 101 of the machining tool 100, each having a conically tapered shape pointing towards the machining tool 100 and a plane contact surface on their respective end face. For example, each spindle nose may be formed as a tapered shank 1:4 according to DIN ISO 702-1:2010-04.

Thus, there is a conical connection with a face contact between each of the flange sockets 111, 121 and the spindle noses 325, 335. The conical connections may have different diameters at the two ends of the machining tool 100 to ensure that the machining tool 100 can only be received in the correct orientation between the spindle noses 325, 335.

The machining tool 100 is axially clamped between the spindle noses 325, 335 by a pull rod 370 and a clamping nut 372. For this purpose, the machining tool 100 and the second spindle shaft 332 each have a central axial bore extending therethrough. At its tool end, the first spindle shaft 322 also has a central axial bore. An internal thread is formed in this bore. The pull rod 370 is inserted through the central bores of the spindle shaft 332 and the machining tool 100. At its end facing the first spindle unit 320, the pull rod 370 has an external thread which is screwed into the internal thread of the first spindle shaft 322. At its other end, it also has an external thread. The clamping nut 372 is screwed onto this external thread. By tightening the clamping nut 372, the clamping nut 372 exerts an axial pressure on the second spindle shaft 332 in the direction of the machining tool 100. This causes the machining tool 100 to be axially clamped between the spindle noses 325, 335. The result is a single continuous shaft with high bending and torsional rigidity.

A first balancing unit 350 is arranged on the first spindle shaft 322 in the axial region between the housing 321 of the first spindle unit 320 and the machining tool 100. A second balancing unit 360 is arranged on the second spindle shaft 332 axially between the housing 331 of the second spindle unit 330 and the machining tool 100. The balancing units 350, 360 surround the respective spindle shaft 322, 332 outside the housing of the respective spindle unit 320, 330. They each comprise a housing which tapers from the associated spindle unit towards the machining tool 100. The tapered outer contour of the balancing units 350, 360 reduces the risk of collision between the balancing units and a workpiece. Each of the balancing units 350, 360 is configured as a ring balancing system. The two balancing units 350, 360 serve to balance the system comprising the machining tool 100 and the spindle shafts 322, 332 clamped thereto in two balancing planes. Alternatively, it is conceivable to arrange at least one balancing element in the hub flange.

Clamping Nut

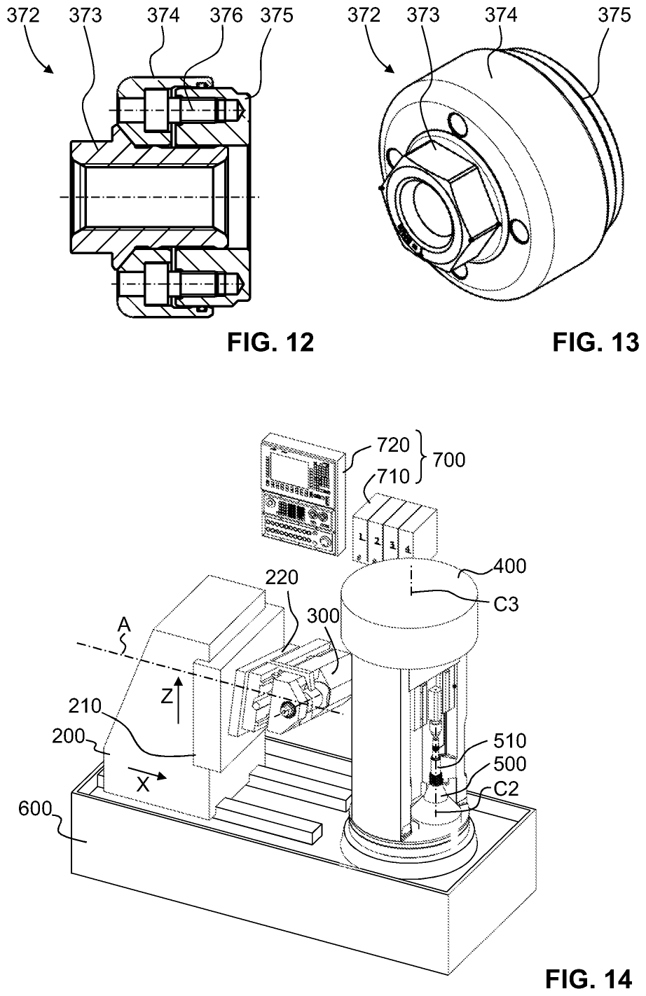

FIGS. 12 and 13 illustrate an exemplary clamping nut 372, such as may be used in the tool head described above.

The clamping nut 372 includes a base element 373 defining a central bore having an internal thread for screwing the base element 373 onto a pull rod having a corresponding external thread. At one end, the base element 373 is externally formed in the manner of a hex nut. A support ring 374 is mounted on the base element 373. It rests against a collar of the base element 373 in such a way that it is prevented from moving axially in one direction (to the left in FIG. 9). Furthermore, an annular axial push element 375 is axially displaceably guided on the base element 373. A plurality of actuating elements 376 in the form of pressure screws are screwed into the axial push element 375 and are axially supported on the support ring 374 in such a way that they are prevented from moving axially along one direction (to the left in FIG. 9). By unscrewing the pressure screws from the axial push element 375, the axial push element 375 is advanced relative to the base element 373 along the direction opposite to the supporting direction (to the right in FIG. 9).

In order to clamp a tool 100 between the two spindle shafts 322, 332, the axial push element 375 is first moved fully back relative to the base element 373 by screwing the pressure screws as far as possible into the axial pressure element 375. Now, the clamping nut 372 is screwed onto the pull rod 370 and, with the aid of the externally formed hexagon of the base element 373, is adjusted against the second spindle shaft 332. This is done with a relatively low torque. Subsequently, with the aid of the pressure screws, the annular axial push element 375 is advanced in a controlled manner in the direction of the second spindle shaft 332 until the desired clamping force acts on the tool 340. Thereby, the axial push element 375 bears against the second spindle shaft 332 with an annular contact surface.

Of course, other constructions of a clamping nut can also be used, as known per se from the prior art. For example, the transmission of force may be effected in a different manner than illustrated. In particular, a hydraulic clamping nut may can be used.

Instead of a clamping nut with internal thread, a clamping element may also be used which is connectable to the pull rod in a way other than via a screw connection, e.g. via a bayonet or via a clamping bush.

Configuration of an Exemplary Machine Tool

FIG. 14 illustrates an example of a machine tool for hard finishing of gears by generating gear grinding. The machine comprises a machine bed 600 on which a tool carrier 200 is arranged so as to be displaceable along a horizontal infeed direction X. A Z-slide 210 is arranged on the tool carrier 200 so as to be displaceable along a vertical direction Z. The Z-slide 210 carries a swivel body 220, which is pivotable relative to the Z-slide 210 about a horizontal swivel axis A. The pivot axis A is parallel to the infeed direction X. The tool head 300, shown only symbolically, is arranged on the pivot body 220. The shift direction Y is perpendicular to the X-axis and at an angle to the Z-axis adjustable about the A-axis.

Furthermore, a pivotable workpiece carrier in the form of a rotary turret 400 is arranged on the machine bed 600. The rotary turret 400 is pivotable about a vertical swivel axis C3 between several rotational positions. It carries two workpiece spindles 500, on each of which a workpiece 510 can be clamped. Each of the workpiece spindles 500 is drivable to rotate about a workpiece axis. In FIG. 12, the workpiece axis of the visible workpiece spindle 500 is designated C2. The workpiece axis of the workpiece spindle not visible in FIG. 12 is designated C1 axis. The two workpiece spindles are located on the rotary turret 400 in diametrically opposite positions (i.e., offset by 1800 with respect to the swivel axis C3). In this way, one of the two workpiece spindles can be loaded and unloaded while a workpiece is being machined on the other workpiece spindle. This largely avoids undesirable non-productive times. Such a machine concept is known, for example, from WO 00/035621 A1.

The machine has a machine control system 700, shown only symbolically, which includes a plurality of control modules 710 and a control panel 720. Each of the control modules 710 controls a machine axis and/or receives signals from sensors.

Other Variations

The interface between the spindle shafts 322, 332 and the machining tool 100 may also be formed differently than in the embodiments described above. In particular, a different type of conical connection may be used. Any known conical connections may be used, for example the embodiments A, BF, BM, CF or CM mentioned in DIN ISO 666:2013-12. For details, reference is made to DIN ISO 666:2013-12 and to the other standards mentioned therein DIN EN ISO 1119:2012-04, DIN ISO 702-1:2010-04, ISO 12164-1:2001-12 and ISO 12164-2:2001-12.

Instead of, as explained above, by a machine-readable data carrier, or in addition thereto, the identification of the hub flange or of the tool formed therewith may also be effected by other means, for example by a mechanical encoding. The coding may be carried out, for example, by means of one or more notches which allow a unique identification of at least the type of the hub flange.

The pull rod 370 may extend through the first spindle shaft 322 instead of through the second spindle shaft 332 and may be connected at its end to the second spindle shaft 332. Accordingly, the clamping element then exerts an axial force on the first spindle shaft in the direction of the second spindle shaft.

In order to clamp the machining tool 100 axially between the first spindle shaft 322 and the second spindle shaft 332, instead of a central pull rod or in addition thereto, two or more pull rods may be used which extend parallel to each other and radially spaced apart from the tool spindle axis B and are arranged at different angular positions relative to the tool spindle axis B.

The fixing and axial clamping of the machining tool 100 between the first spindle shaft and the second spindle shaft in compression may also be performed in a way other than with a continuous pull rod, for example with clamping systems arranged inside the respective spindle shaft. For this purpose, the connection between the machining tool and the spindle shafts may be made, for example, by means of hollow shank tapers (HSK) according to ISO 12164-1:2001-12 and ISO 12164-2:2001-12.

The tool body may be formed differently than in the embodiments explained above. In particular, the tool body may also be multi-part.

The tool body may be dressable or non-dressable. A non-dressable tool body may, for example, have a metallic base body with a hard material coating applied thereto. Such a tool body may in principle be mounted on the hub flange in the same way as a dressable tool body. Instead, however, it is also conceivable to manufacture a one-piece tool whose outer contour in the region of the connection points with the tool spindles is formed in accordance with the flange sockets 111, 121, the hard material coating being an integral component of this one-piece tool. The tool may then be identified in the same way as shown above for the hub flange, by means of a machine-readable data carrier and/or by mechanical encoding. Such one-piece tools may be part of a tool assortment comprising tools with the hub flange shown above as well as one-piece tools.

### LIST OF REFERENCE SIGNS

100 grinding tool
101 hub flange
110 fixed flange
111 first flange socket
112 outer lateral surface
113 collar
114 clamping surface
115 connection region
116 central bore
117 positioning bore
118 receiving notch
119 balancing bore
120 counterflange
121 second flange socket
122 outer surface
123 collar
124 clamping surface
125 cap screw
126 central bore
127 external thread
130 grinding wheel
131, 132 intermediate washer
140 positioning ring
141 longitudinal groove
142 fixation pin
144 clamping surface
145 intermediate ring
146 adjusting screw
147 positioning pin
148 spring element
150 conical connection
151 inner cone (taper socket)
152 outer cone (taper)
153 first plane contact surface
154 second plane contact surface
200 tool carrier
210 Z-slide
220 swivel body
300 tool head
310 base
311 linear guide
312 ball screw drive
320 first spindle unit
321 first spindle housing
322 first spindle shaft
323 first spindle bearing
324 drive motor
325 first spindle nose
326 guide shoe
330 second spindle unit
321 second spindle housing
332 second spindle shaft
333 second spindle bearing
335 second spindle nose
336 guide shoe
350 first balancing unit
360 second balancing unit
370 pull rod
372 clamping nut
400 rotary turret
500 workpiece spindle
510 workpiece
600 machine bed
700 machine control system
710 control module
720 control panel
X, Y, Z linear axis
A swivel axis
B tool axis
C1, C2 workpiece axis
C3 tower swivel axis

1. A hub flange for a tool body, comprising:
a fixed flange defining a tool axis, the fixed flange being configured to receive the tool body, wherein a first flange socket is formed on the fixed flange for connection to a first spindle shaft which is rotatable about the tool axis; and
a counterflange which is detachably connected to the fixed flange,
wherein the fixed flange and the counterflange are connected to each other via a conical connection, the conical connection being arranged coaxially with respect to the tool axis and being formed by an inner cone and an outer cone received in the inner cone.

2. The hub flange of claim 1, wherein a second flange socket is formed on the counterflange for connection to a second spindle shaft which is rotatable about the tool axis.

3. The hub flange of claim 1, wherein the inner cone is formed on the fixed flange and the outer cone is formed on the counterflange, or wherein the inner cone is formed on the counterflange and the outer cone is formed on the fixed flange.

4. The hub flange of claim 1, wherein a first plane contact surface is formed adjacent to the inner cone and a second plane contact surface oriented opposite the first plane contact surface is formed adjacent to the outer cone, wherein the first and second plane contact surfaces extend orthogonally to the tool axis, and wherein the fixed flange and the counterflange are pressed together at the first and second plane contact surfaces so as to establish a friction fit.

5. The hub flange of claim 4, wherein the first plane contact surface is arranged adjacent to the inner cone on the front side, and wherein the second plane contact surface surrounds the outer cone.

6. The hub flange of claim 1, comprising a plurality of axial screws axially pressing the fixed flange and the counterflange together at the conical connection.

7. The hub flange of claim 1, wherein the hub flange defines first and second clamping surfaces such that the tool body is axially clampable between the first and second clamping surfaces.

8. The hub flange of claim 7, comprising a positioning ring having an axially variable position relative to the counterflange, wherein the first clamping surface is formed on the fixed flange, and wherein the second clamping surface is formed on the positioning ring.

9. The hub flange of claim 8, wherein the counterflange or the fixed flange has an external thread and the positioning ring has an internal thread complementary thereto, in order to change the axial position of the positioning ring by a screwing movement of the positioning ring relative to the counterflange.

10. The hub flange of claim 9, comprising an intermediate ring disposed axially adjacent to the positioning ring for transmitting an axial clamping force from the positioning ring to the tool body.

11. The hub flange of claim 8, wherein the positioning ring is axially displaceable on the fixed flange and/or on the counterflange, and wherein the hub flange comprises a plurality of threaded elements screwed into the counterflange or into the positioning ring to change the axial position of the positioning ring relative to the counterflange.

12. The hub flange of claim 1, wherein the first and/or second flange sockets is formed as an inner or outer cone with a plane contact surface.

13. The hub flange of claim 1, comprising an axial through bore.

14. A machining tool, comprising:
a hub flange according to claim 1; and
a tool body which is clamped on the hub flange.

15. A tool head for a machine tool comprising:
a machining tool according to claim 14,
a first spindle unit with a first spindle shaft which is mounted in the first spindle unit so as to be rotatable about the tool axis; and
a second spindle unit with a second spindle shaft which is mounted in the second spindle unit so as to be rotatable about the tool axis,
wherein the first spindle unit and the second spindle unit are arranged coaxially with respect to each other in such a way the machining tool is receivable axially between the first spindle shaft and the second spindle shaft.

16. The tool head of claim 15, wherein the machining tool is axially clamped between the first spindle shaft and the second spindle shaft such that an axial compression force acts on both sides of the machining tool.

17. The tool head of claim 16,
wherein the second spindle shaft and the machining tool each have an axial through bore,
wherein the tool head comprises a pull rod extending through the axial through bores of the second spindle shaft and the machining tool, the pull rod being connectable at one end to the first spindle shaft, and
wherein the pull rod is connectable at a second end to the second spindle shaft in such a way that an axial compression force can be generated on the machining tool between the first spindle shaft and the second spindle shaft.

18. The machining tool of claim 14, wherein the tool body is a grinding body.
